(19) United States
(12) Patent Application Publication
(10) Pub. No.: US 2014/0355772 A1
(43) Pub. Date: Dec. 4, 2014

(54) ELECTRONIC DEVICE AND METHOD FOR SWITCHING RECORDING MODES

(71) Applicant: Chiun Mai Communication Systems, Inc., New Taipei (TW)

(72) Inventor: CHENG-PING LIU, New Taipei (TW)

(73) Assignee: CHIUN MAI COMMUNICATION SYSTEMS, INC., New Taipei (TW)

(21) Appl. No.: 14/284,607

(22) Filed: May 22, 2014

(30) Foreign Application Priority Data
May 28, 2013 (TW) 102118862

(51) Int. Cl. H04R 3/00

(52) U.S. Cl. CPC H04R 3/00; H04R 2410/00
USPC 381/26

(57) ABSTRACT

A method for switching recording modes using an electronic device requires a three-axis acceleration senor and at two microphones. The three-axis accelerometer is activated to detect three-axis acceleration values of the electronic device. A handheld direction of the electronic device is determined according to the detected three-axis acceleration values. The method set a recording software of the electronic device to select one of the recording modes to execute a recording function according to the determined handheld direction. The method further selects the first microphone and/or the second microphone to receive external audio signals according to the selected recording mode.

### CROSS-REFERENCE TO RELATED APPLICATIONS

This application claims priority to Taiwanese Patent Application No. 102118862 filed on May 28, 2013 in the Taiwan Intellectual Property Office, the contents of which are incorporated by reference herein.

### FIELD

Embodiments of the present disclosure relate to recording technology, and particularly to an electronic device and method for switching recording modes of the electronic device.

### BACKGROUND

Most electronic devices (e.g. mobile phones or tablet computers) can support both a monophonic recording mode and a stereophonic recording mode. When a user wants to activate recording an audio, the user needs to select one recording mode manually.

### BRIEF DESCRIPTION OF THE DRAWINGS

Implementations of the present disclosure will be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of one embodiment of an electronic device including a recording mode switching system.

FIG. 2 is a block diagram of one embodiment of function modules of the recording mode switching system of the electronic device in FIG. 1.

FIG. 3 is a flowchart of one embodiment of a method for switching recording modes using the electronic device of FIG. 1.

FIG. 4 is an isometric diagram of an embodiment of a coordinate system of a three-axis accelerometer in the electronic device of FIG. 1.

FIG. 5 is a first isometric diagram of an embodiment of handholding the electronic device for selecting a first recording mode.

FIG. 6 is a second isometric diagram of an embodiment of handholding the electronic device for selecting a second recording mode.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more. ”

In the present disclosure, “module,” refers to logic embodied in hardware or firmware, or to a collection of software instructions, written in a program language. In one embodiment, the program language can be Java, C, or assembly. One or more software instructions in the modules can be embedded in firmware, such as in an EPROM. The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives.

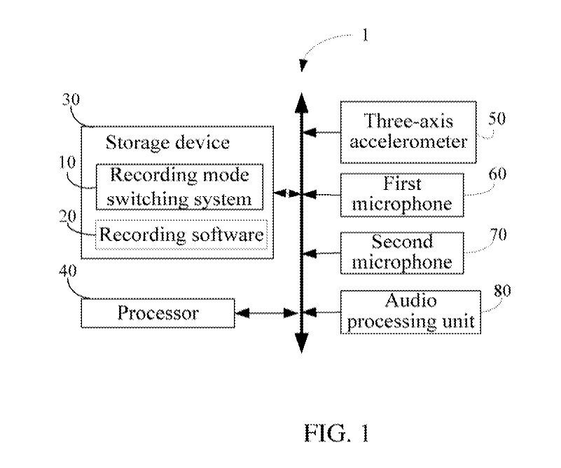

FIG. 1 is a block diagram of one embodiment of an electronic device 1 including a recording mode switching system 10. In one embodiment, the electronic device 1 can be a mobile phone, tablet computer, a notebook computer, or any other electronic device. The electronic device 1 further includes, but is not limited to, recording software 20, a storage device 30, at least one processor 40, a three-axis accelerometer 50, at least two microphones (e.g., a first microphone 60 and a second microphone 70), and an audio processing unit 80. The recording software 20 can execute at least a recording function of recording external audio signals, a storing function of storing recording files, and a playing function of playing recording files.

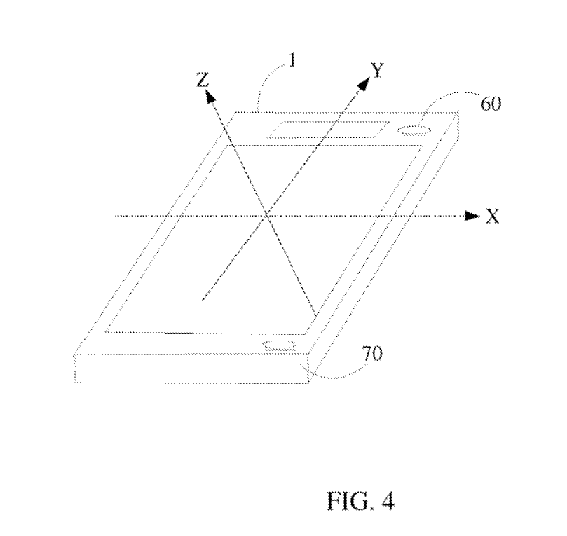

The storage device 30 can be a memory of the electronic device 1 or an external storage card, such as a smart media card or a secure digital card. The at least one processor 40 executes one or more computerized codes and other applications of the electronic device 1 to provide functions of the recording mode switching system 10. The three-axis accelerometer 50 detects three-axis acceleration values of the electronic device 1, such as the three-axis acceleration values along an x-axis, a y-axis, and a z-axis based on a preset coordinate system (as shown in FIG. 4) of the electronic device 1.

The first microphone 60 can be located at an upper right corner of the electronic device 1. As shown in FIG. 4, the first microphone 60 is located on the right side of a handset of the electronic device 1. The second microphone 70 can be located at a symmetrical position corresponding to the position of the first microphone 70. As shown in FIG. 4, the second microphone 70 is located at the lower right corner of the electronic device 1. The electronic device 1 executes a stereophonic recording function by using both the first microphone 60 and the second microphone 70 at different positions to receive external audio signals.

The received audio signals from the first microphone 60 and/or the second microphone 70 are transmitted to the audio processing unit 80 to be processed. The audio processing unit 80 includes, but is not limited to, at least two groups of analog-to-digital converters (ADCs), filter circuits, codecs (encoders and decoders) to convert analog audio signals from the at least two microphones into digital signals for transmission or storage. The audio process unit 80 may compress the digital signals to be one recording file. That is, the audio signals received from each of the microphones can be processed by the audio processing unit 80 to generate a corresponding recording file. In other embodiments, the audio processing unit 80 further can decompress and decode the recording file stored in the storage device 30 for converting the recording file to be digital signals, and further convert the digital signals to be corresponding analog audio signals.

The recording software 20 includes at least two recording modes for recording audio signals. Under the first recording mode, both of the first microphone 60 and the second microphone 70 are used to record the external audio signals. Under the second recording mode, one of the first microphone 60 and the second microphone 70 is used to record the external audio signals.

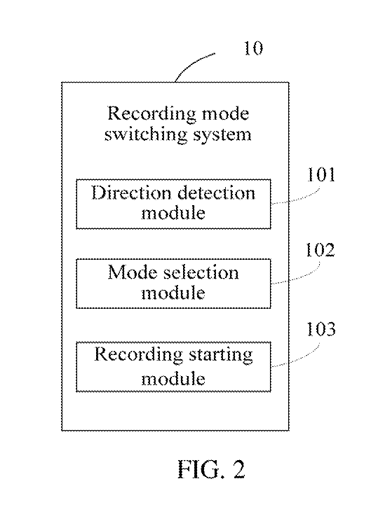

FIG. 2 is a block diagram illustrating function modules of the recording mode switching system 10. In this embodiment, the recording mode switching system 10 includes a direction detection module 101, a mode selection module 102, and a recording activating module 103. The modules 101-103 include computerized code in the form of one or more programs that are stored in the storage device 30. The computerized code includes instructions that are executed by the at least one processor 40 to provide functions of the recording mode switching system 10. A description of each module of the recording mode switching system 10 is given in the following paragraphs.

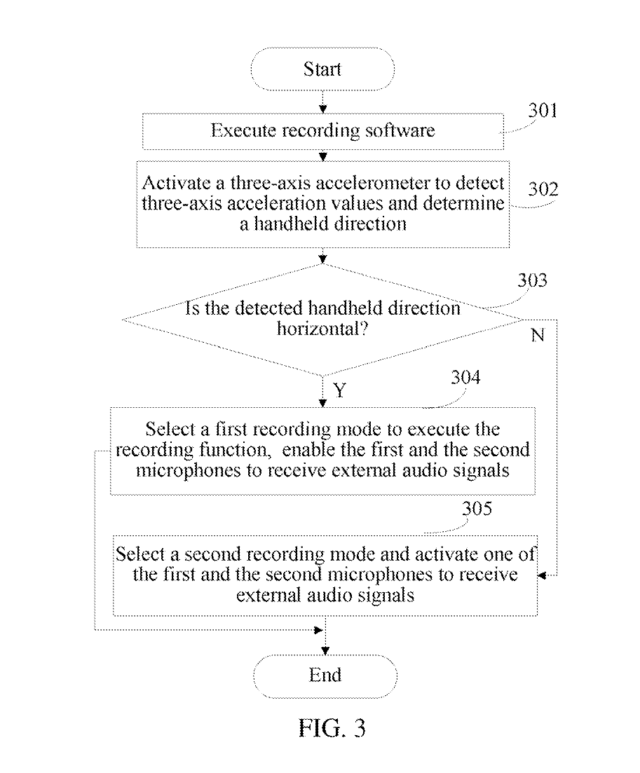

FIG. 3 is a flowchart of one embodiment of a method for switching recording modes of a testing sample using the electronic device. Depending on the embodiment, additional blocks may be added, others removed, and the ordering of the blocks may be changed.

In block 301, the electronic device 1 executes the recording software 20.

In block 302, the direction detection module 101 activates the three-axis accelerometer 50 to detect three-axis acceleration values of the electronic device 1, and determines a handheld direction according to the detected three-axis acceleration values. In one embodiment, the three-axis acceleration values include an acceleration value “x” along the x-axis, an acceleration value “y” along the y-axis, and an acceleration value “z” along the z-axis. Each of the three-axis acceleration values may be positive or negative when each of the three-axis acceleration values is at a positive orientation or at a negative orientation along the x-axis, y-axis, or z-axis.

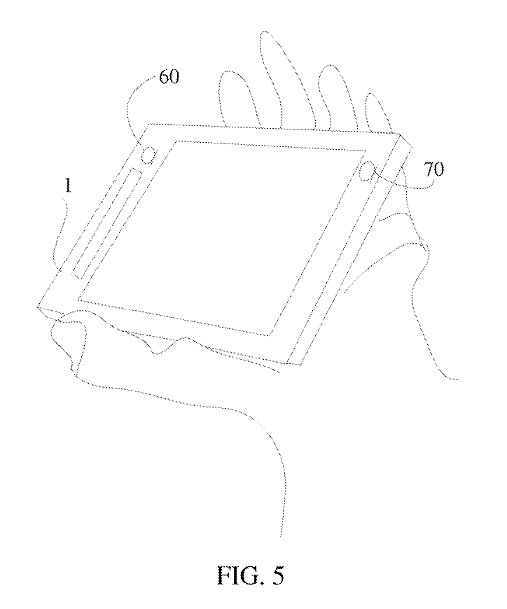

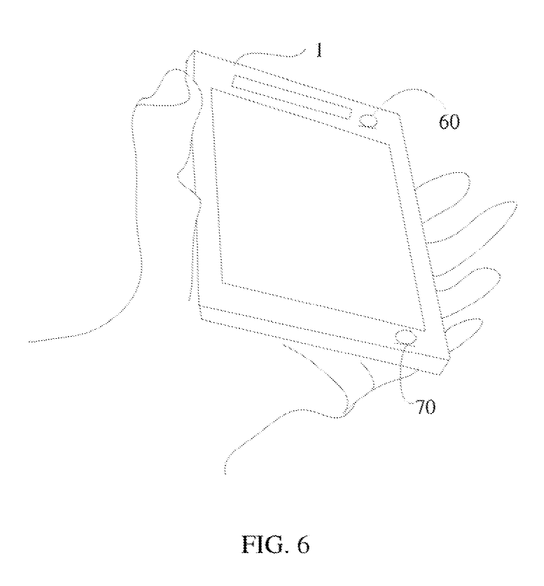

If an absolute value of the acceleration value “x” is greater than a first acceleration threshold (e.g. 5 m/s²), and both of the acceleration values “y” and “z” are equal to a second acceleration threshold, the direction detection module 101 determines that the handheld direction of the electronic device 1 is horizontal (e.g. as shown in FIG. 5). The second threshold is set to be approximated to zero or equal to zero. If an absolute value of the acceleration value “y” is greater than the first acceleration threshold, and both of the acceleration values “y” and “z” are equal to the second acceleration threshold, the direction detection module 101 determines that the handheld direction of the electronic device 1 is vertical (e.g. as shown in FIG. 6).

In block 303, the direction detection module 101 determines whether the handheld direction of the electronic device 1 is horizontal. If the handheld direction is horizontal, block 304 is implemented. If the handheld direction is not horizontal, block 305 is implemented.

In block 304, the mode selection module 102 controls the recording software 20 to select a first recording mode to execute the recording function and the recording activating module 103 activates both of the first microphone 60 and the second microphone 70 to receive external audio signals. Both of the first microphone 60 and the second microphone 70 transmit the received external audio signals to the audio processing unit 80 to be processed respectively, and the audio processing unit 80 generates two recording files. The recording software 20 may merge the two recording files into an independent recording file, and save the independent recording file in a stereo format.

In one embodiment, when the handheld direction is horizontal, and the acceleration value “x” is greater than the first acceleration threshold, the audio signals received from the first microphone 60 is determined to be left channel signals and the audio signals received from the second microphone 70 is determined to be right channel signals. When the handheld direction is horizontal, and the acceleration value “x” is lower than a negative value of the first acceleration threshold (e.g. −5(m/s²)), the audio signals received from the first microphone 60 is determined to be the right channel signals and the audio signals received from the second microphone 70 is determined to be the left channel signals.

In block 305, the mode selection module 102 controls the recording software 20 to select a second recording mode to execute the recording function and the recording activating module 103 activates one of the first microphone 60 and the second microphone 70 to receive the external audio signals. The audio processing unit 80 generates a recording file by processing the received external audio signals . The recording software 20 saves the recording file in a mono format.

In one embodiment, when the handheld direction is vertical, and the acceleration value “y” is greater than the first acceleration threshold, the recording activating module 103 selects the first microphone 60 to receive external audio signals, and disables the second microphone 70. When the handheld direction is vertical, and the acceleration value “y” is less than a negative value of the first acceleration threshold, the recording activating module 103 selects the second microphone 70 to receive external audio signals, and disables the first microphone 60.

All of the processes described above may be embodied in, and fully automated via, functional code modules executed by one or more general purpose processors such as the processor 40. The code modules may be stored in any type of non-transitory readable medium or other storage device such as the storage device 30. Some or all of the methods may alternatively be embodied in specialized hardware. Depending on the embodiment, the non-transitory readable medium may be a hard disk drive, a compact disc, a digital versatile disc, a tape drive, or other suitable storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. An electronic device, comprising:
a three-axis accelerometer;
at least a first microphone and a second microphone;
at least one processor; and
a storage device storing one or more programs, which when executed by the at least one processor, cause the at least one processor to:
activate the three-axis accelerometer to detect three-axis acceleration values of the electronic device;
determine a handheld direction of the electronic device according to the detected three-axis acceleration values;
control recording software of the electronic device to select a recording mode according to the determined handheld direction; and
activate at least one of the first microphone and the second microphone to receive external audio signals for executing a recording function according to the selected recording mode.

2. The electronic device according to claim 1, wherein the recording software comprises at least a first recording mode and a second recording mode for recording the external audio signals, both of the first microphone and the second microphone are used to record the external audio signals under the first recording mode, and one of the first microphone and the second microphone is used to record the external audio signals under the second recording mode.

3. The electronic device according to claim 2, wherein the at least one processer further:
controls the recording software to select the first recording mode when the handheld direction of the electronic device is horizontal; or
controls the recording software to select the second recording mode when the handheld direction of the electronic device is not horizontal.

4. The electronic device according to claim 3, wherein the at least one processer further:
controls the recording software to merge two recording files generated from the first microphone and the second microphone into an independent recording file and storing the independent recording file in a stereo format, when the recording software selects the first recording mode to execute the recording function; or
controls the recording software to store a recording file generated from one of the first microphone and the second microphone in a mono format, when the recording software selects the second recording mode to execute the recording function.

5. The electronic device according to claim 1, wherein the first microphone is located at an upper right corner of the electronic device, and the second microphone is located at a symmetrical position corresponding to the position of the first microphone, and the electronic device executes a stereophonic recording function by using the first microphone and the second microphone at different positions.

6. A method for switching recording modes using an electronic device, the electronic device comprising a three-axis accelerometer, at least a first microphone and a second microphone, the method comprising:
activating the three-axis accelerometer to detect the three-axis acceleration values of the electronic device;
determining a handheld direction of the electronic device according to the detected three-axis acceleration values;
controlling a recording software of the electronic device to select one of the recording modes to execute a recording function according to the determined handheld direction; and
activating at least one of the first microphone and the second microphone to receive external audio signals for executing a recording function according to the selected recording mode.

7. The method according to claim 6, wherein the recording software comprises at least a first recording mode and a second recording mode for recording the external audio signals, both of the first microphone and the second microphone are used to record the external audio signals under the first recording mode, and one of the first microphone and the second microphone is used to record the external audio signals under the second recording mode.

8. The method according to claim 7, further comprising:
controlling the recording software to select the first recording mode when the handheld direction of the electronic device is horizontal; or
controlling the recording software to select the second recording mode when the handheld direction of the electronic device is not horizontal.

9. The method according to claim 8, furthering comprising:
controlling the recording software to merge two recording file generated from the first microphone and the second microphone into an independent recording file and storing the independent recording file as a stereo format, when the recording software selects the first recording mode to execute the recording function; or
controlling the recording software to store a recording file generated from one of the first microphone and the second microphone in a mono format, when the recording software selects the second recording mode to execute the recording function.

10. The method according to claim 6, wherein the first microphone is located at an upper right corner of the electronic device, and the second microphone is located at a symmetrical position corresponding to the position of the first microphone, and the electronic device executes a stereophonic recording function by using the first microphone and the second microphone at different positions.

11. A non-transitory storage medium having stored thereon instructions that, when executed by at least one processor of an electronic device, cause the processor to perform a method for switching recording modes using the electronic devices, the electronic device comprising a three-axis accelerometer, at least a first microphone and a second microphone, the method comprising:
activating the three-axis accelerometer to detect the three-axis acceleration values of the electronic device;
determining a handheld direction of the electronic device according to the detected three-axis acceleration values;
controlling a recording software of the electronic device to select one of the recording modes to execute a recording function according to the determined handheld direction; and
activate at least one of the first microphone and the second microphone to receive external audio signals for executing a recording function according to the selected recording mode.

12. The storage medium according to claim 11, wherein the recording software comprises at least a first recording mode and a second recording mode for recording the external audio signals, both of the first microphone and the second microphone are used to record the external audio signals under the first recording mode, and one of the first microphone and the second microphone is used to record the external audio signals under the second recording mode.

13. The method according to claim 12, further comprising:
controlling the recording software to select the first recording mode when the handheld direction of the electronic device is horizontal; or
controlling the recording software to select the second recording mode when the handheld direction of the electronic device is not horizontal.

14. The method according to claim 11, furthering comprising:
controlling the recording software to merge two recording file generated from the first microphone and the second microphone into an independent recording file and storing the independent recording file in a stereo format, when the recording software selects the first recording mode to execute the recording function; or
controlling the recording software to store a recording file generated from one of the first microphone and the second microphone in a mono format, when the recording software selects the second recording mode to execute the recording function.

15. The method according to claim 11, wherein the first microphone is located at an upper right corner of the electronic device, and the second microphone is located at a symmetrical position corresponding to the position of the first microphone, and the electronic device executes a stereophonic recording function by using the first microphone and the second microphone at different positions.
